(19) United States
(12) Patent Application Publication
(10) Pub. No.: US 2026/0160244 A1
(43) Pub. Date: Jun. 11, 2026

(54) VACUUM PUMPS WITH INTERNAL OIL TEST

(71) Applicant: NAVAC Inc., Lyndhurst, NJ (US)

(72) Inventors: Andrew Greaves, Versailles, KY (US); Lintao Lu, Harrison, NJ (US); Jason Sierra, Vernon, NJ (US); Zhukai Zhang, Ridgewood, NJ (US)

(21) Appl. No.: 19/258,761

(22) Filed: Jul. 2, 2025

Related U.S. Application Data
(60) Provisional application No. 63/729,767, filed on Dec. 9, 2024.

(51) Int. Cl. F04B 51/00; G01L 21/00

(52) U.S. Cl. CPC F04B 51/00; G01L 21/00

(57) ABSTRACT

The present invention provides vacuum pumps and methods with internal oil health test function to assess condition of the oil contained within the vacuum pumps, and to determine if an oil change is needed. The vacuum pump may include an oil tank for containing oil; a motor for producing vacuuming power; and an inlet to be connected either directly or indirectly to a vacuum gauge, together with a built-in module or function configured for conducting an internal oil health test to assess condition of the oil contained within the oil tank.

### CROSS-REFERENCE TO RELATED APPLICATION

This application claims priority to United States Application No. 63/729,767, filed on Dec. 27, 2024, the contents of which are incorporated herein by reference in their entirety.

### BACKGROUND OF THE INVENTION

When dealing with vacuum pumps, vacuum pump oil plays a critical role in the performance of the vacuum pump. Vacuum pump oil is a specialized lubricant used in vacuum pumps to reduce friction, provide sealing, and ensure efficient operation under specific pressure conditions. This industry operates at the intersection of materials science, chemical engineering, and mechanical design, supplying essential products for diverse sectors such as manufacturing, healthcare, and research. Vacuum pump oil plays a critical role in the performance of a vacuum pump and in various applications requiring controlled vacuum environments. The vacuum pump oil industry evolved in tandem with the development of vacuum technology in the early 20th century. The need for high-quality lubricants arose as vacuum systems became integral to industrial and scientific applications. With progress in chemical synthesis and materials processing, vacuum pump oil has become highly specialized, with formulations tailored to specific pump types and operational environments.

It is well known that vacuum pump oil needs to be changed from time to time to keep the pump running at optimal conditions. But there's no consensus in the industry as to when exactly the oil should be changed.

For a long time, there's been a misconception in the field: many believe that vacuum pump oil must be changed every time the pump is used. In fact, recent survey suggests that over 30% of technicians are currently following this outdated practice. This approach is not only unnecessary but also wasteful in terms of time and money, leading to increased costs and environmental impact. On the other hand, some technicians relied on the visual condition (e.g., color) of the oil to guess whether an oil change is needed. Nevertheless, that approach is not accurate, as oil may have been in a bad condition long before its color change.

To overcome those drawbacks, it is desired to have improved smart vacuum pumps with an internal oil test that can measure and monitor the oil condition, in order to properly and accurately determine whether oil change is needed for the pump, thereby providing improved safety, cost efficiency and productivity.

### BRIEF SUMMARY OF THE INVENTION

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

The present invention provides a smart vacuum pump with an innovative internal oil heath test function. The oil health test function, which may be performed by one click, allows a user to quickly assess the condition of oil in the vacuum pump, thereby providing a measurable solution so that oil change is performed only when necessary. The pump may also integrate with a Bluetooth vacuum gauge and provide real-time system vacuum readings displayed on the pump via a computer or a mobile device (e.g., via mobile application). In addition, with user-friendly features like automated decay testing, preset vacuum targets, and a built-in solenoid valve for vacuum preservation, this pump is designed for “set it and forget it” convenience.

The vacuum pumps according to the present invention are designed to remove air, moisture, and other non-condensable gases from sealed HVACR systems. They can be used for evacuation of HVACR repair or new installations, specially designed for A2L refrigerants such as, R-32, 1234yf, R-600a, R-454B. They can also be used as other common refrigerants such as, R-12, R-22, R-41 0A, R-404A, R-134A, etc.

Moreover, the vacuum pumps according to the present invention may have some other special features, such as integrated pump structure, which is designed with high precision and allows for deep ultimate vacuum levels; forced oil lubrication, which ensures proper vane sealing, enhanced cooling, and improved reliability; large, easy-to-see oil-level window, which helps prevent oil shortages by providing a clear view of the oil level.

One aspect of the present invention provides a vacuum pump, comprising: an oil tank for containing oil; a motor for producing vacuuming power; an inlet to be connected either directly or indirectly to a vacuum gauge; and a built-in module configured for conducting an internal oil health test to assess condition of the oil contained within the oil tank.

In some embodiments, the vacuum pump also includes an interface configured to display data and receive input from a user.

In some embodiments, the internal oil health test is performed after the inlet is connected to the vacuum gauge and the motor is started.

In some embodiments, the built-in module is configured to perform the following: (i) predetermining a target vacuum level and a preset time period for the internal oil health test; (ii) starting the internal oil health test and running the motor for the preset time period; (iii) testing a tested vacuum level within the vacuum pump at the end of the preset time period; and comparing the tested vacuum level with the target vacuum level, in order to assess the condition of the oil and determine if an oil change is recommended.

In some embodiments, when the tested vacuum level is less than or equal to the target vacuum level, the condition of the oil is determined to be good and pass the test; and when the tested vacuum level exceeds the target vacuum level, the condition of the oil is determined to be not good, and the oil change is recommended.

In some embodiments, the interface is configured to receive data from the built-in module and display test results or recommendation for the oil change after the internal oil health test.

In some embodiments, the target vacuum level and preset time period are predetermined by the built-in module, based on a previously determined relationship among vacuum level achievable by the vacuum pump, standard time required to achieve said vacuum level, and condition of oil contained in the vacuum pump.

In some embodiments, the target vacuum level and the preset time period are adjustable by the user via the interface.

In some embodiments, the vacuum pump includes a connector configured to connect the inlet and the vacuum gauge. For instance, the connector may be contained within a base of the vacuum pump and movable by the user.

In some embodiments, the vacuum gauge is contained by or attached to the pump.

In some embodiments, the inlet is a ¼″ air inlet.

In another aspect, the present invention provides a method for assessing condition of oil contained in a vacuum pump, comprising the following steps: (i) connecting a vacuum gauge to an inlet of the vacuum pump; (ii) predetermining a target vacuum level and a preset time period for an internal oil health test; (iii) starting the internal oil health test and running motor in the vacuum pump for the preset time period; (iv) testing a tested vacuum level within the vacuum pump at the end of the preset time period; (v) comparing the tested vacuum level with the target vacuum level, in order to assess the condition of the oil and determine if an oil change is recommended.

In some embodiments, the internal oil health test is conducted by a built-in module in the vacuum pump.

In some embodiments, the target vacuum level and the preset time period are predetermined by the built-in module, based on a previously determined relationship among vacuum level achievable by the vacuum pump, standard time required to achieve said vacuum level, and condition of oil contained in the vacuum pump.

In some embodiments, the inlet is a ¼″ air inlet. Steill in some embodiments, the inlet is connected to the vacuum gauge by a connector, said connector being contained by the vacuum pump and movable by a user.

In some embodiments, the method further include a step of displaying test results or recommendation of the oil change on an interface contained by the vacuum pump.

In some embodiments, the target vacuum level and the preset time period are adjustable by the user via the interface.

As used herein, the singular forms “a,” “an” and “the” include plural referents unless the context clearly dictates otherwise.

As used herein, the terms “include”, “includes” and “including” are meant to be non-limiting.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Unless otherwise defined herein, scientific and technical terms used in connection with the present application shall have the meanings that are commonly understood by those of ordinary skill in the art to which this disclosure belongs. It should be understood that this invention is not limited to the particular methodology, protocols, and reagents, etc., described herein and as such can vary. Other terms are defined herein within the description of the various aspects of the invention.

### BRIEF DESCRIPTIONS OF THE FIGURES

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 illustrates a perspective view of a vacuum pump according to one embodiment of the preset invention.

FIG. 2 illustrates a front view of the vacuum pump in FIG. 1.

FIG. 3 illustrates a back view of the vacuum pump in FIG. 1.

FIG. 4 illustrates a side view of the vacuum pump in FIG. 1.

FIG. 5 illustrates another side view of the vacuum pump in FIG. 1.

FIG. 6 illustrates a top view of the vacuum pump in FIG. 1.

FIG. 7 illustrates a bottom view of the vacuum pump in FIG. 1.

FIG. 8 illustrates an exemplary interface according to one embodiment of the present invention.

FIG. 9 illustrates a vacuum pump with a gauge attached to the pump.

### DETAILED DESCRIPTION OF THE INVENTION

Reference will now be made in detail to the preferred embodiments of the invention, examples of which are further illustrated. While the invention will be described in conjunction with the preferred embodiments, it will be understood that they are not intended to limit the invention to these embodiments. To the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and other features have not been described in detail as not to unnecessarily obscure aspects of the present invention.

Generally speaking, various embodiments of the present invention provide for smart vacuum pumps with an internal oil test module that can measure and monitor the oil condition, in order to properly and accurately determine whether oil change is needed for the pump. The aim of the present invention is to keep monitoring the quality of vacuum pump oil, so that technicians are able to be reminded to change vacuum pump oil at a reasonable timing.

With reliability, efficiency and easy operation, the vacuum pump of this invention sets a new standard in system evacuation, helping users save time, reduce costs, and deliver precise, effective evacuations every time. With the internal or built-in oil-health test function, the smart vacuum pump of the present invention can conveniently and efficiently eliminate changing oil that is still good for vacuum pump when the test shows the oil is of usable condition, or protect the vacuum pump and increase vacuuming efficiency when the test shows the oil is of poor quality and should be changed, meaning changing the oil when it is needed.

In some embodiments, the smart vacuum pump features an oil health test mode that allows technicians to quickly assess the current condition of the oil by pushing a button. This test evaluates whether the oil can achieve an acceptable vacuum level within a minute, serving as a reliable indicator of whether an oil change is really needed. By relying on this real-time assessment rather than following a vague assumption, technicians can avoid premature oil changes while ensuring they don't overlook contaminated oil.

This innovation has several key benefits. First, it reduces oil consumption, allowing technicians to use vacuum pump oil more efficiently. A typical service technician, assuming they handle 345 jobs (5 peak months * 23 day/month * 3 jobs/day) that requires a vacuum pump annually, consumes approximately 54 gallons (20 oz * 345 jobs) of vacuum pump oil each year, which costs more than $2,000 (54 gallon * $40/gallon) if changing oil every time. By changing oil only when necessary, technicians can significantly cut down on waste, saving 50%˜80% of the oil typically used in their operations (assuming techs change oil only once every 2˜5 pump use), resulting in not only >$1,000 cost saving but also minimizes the frequency of oil purchases, reducing the associated production and transportation emissions.

Considering a bigger picture, the impact of outdated practices in the HVAC industry becomes clear. With approximately 450,000 HVAC service technicians in the U.S., around 135,000 technicians—or 30%—are following the old custom of changing vacuum pump oil after every use. This collectively results in an annual waste of over 7 million gallons of vacuum pump oil. By transitioning to the vacuum pumps according to the present invention, which incorporate a smarter oil management system, technicians can cut oil consumption by at least 50%, leading to a reduction of over 3.5 million gallons of oil—equivalent to approximately 11,600 tons—every year across the industry. This shift not only minimizes waste and lowers costs but also significantly reduces the environmental footprint of HVAC operations.

Producing vacuum pump oil requires a substantial amount of energy. From extraction and refining to packaging and transportation, the process consumes fossil fuels and generates carbon emissions. In fact, it is estimated that producing just 1 gallon of vacuum pump oil can emit up to 28.5 lbs. of CO₂ into the atmosphere. Furthermore, 100 million pounds of CO₂ emissions translates to burning approximately 5.1 million gallons of gasoline and with an average gas-powered car achieving 25 miles per gallon, this is equivalent to driving about 127.5 million miles. It can be concluded that a reduction of over 3.5 million gallons of oil will reduce 50,000 tons of CO2, equivalent to 120 million miles of travel on an average gas car. By extending the life of your oil with the NP8DSV's Oil Health Test Mode, a user can directly contribute to a reduction in carbon emissions and lessen the overall environmental impact by a vacuum pump.

In addition, the oil management system included by the vacuum pumps of this invention saves time for technicians on the job. Frequent oil changes can be time-consuming, often requiring 5-10 minutes per change. With fewer oil changes needed, technicians can save at least 20 hours annually (345 jobs*7.5 minutes for oil change*50% time saving). This time savings alone represents an additional $2,000 in value per year, further enhancing the overall cost efficiency and productivity provided by the NP8DSV.

A smart vacuum pump of this invention enables its users to embrace a more sustainable approach to their work. This feature empowers users to make informed decisions about oil changes, conserving resources and reducing waste without compromising on the performance of their vacuum pump. It's a win-win solution: you save time, money, and help protect the planet-all while maintaining the high standards of service your clients expect.

The invention is further elucidated with specific examples. It is understood that these examples are only used to describe the invention but not intended to limit the scope of invention. The experimental methods with no specific conditions in the following examples, are usually prepared under conventional conditions in literature or according to the conditions suggested by the excipient manufacturer. Unless specifically stated, all percentages, ratios, proportions, or fractions in this invention are calculated by weight by weight. Unless specifically defined in this invention, all professional and scientific terms used herein have the same meaning as well-trained personnel may be familiar with. In addition, any methods and materials similar or equivalent to those recorded in this invention can be applied to this invention. The preferred embodiments and materials described herein are used only for exemplary purposes.

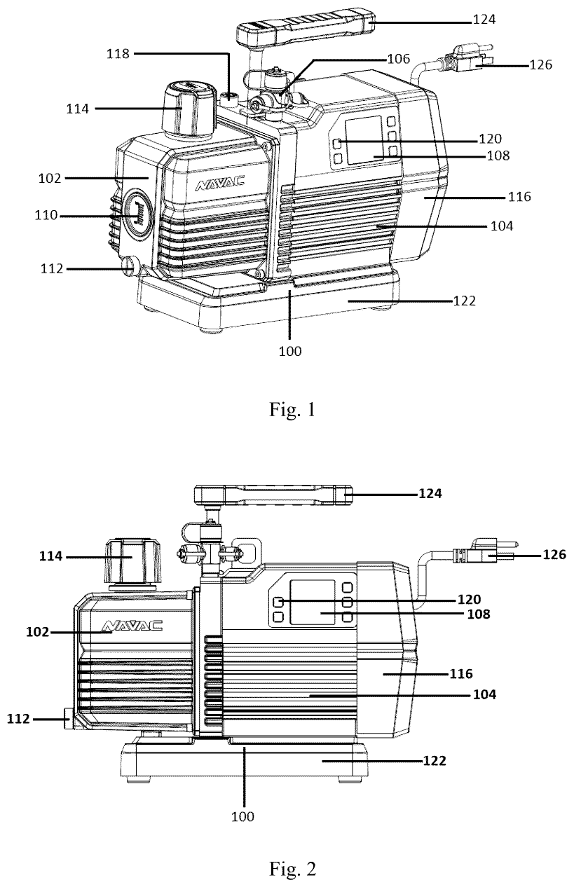

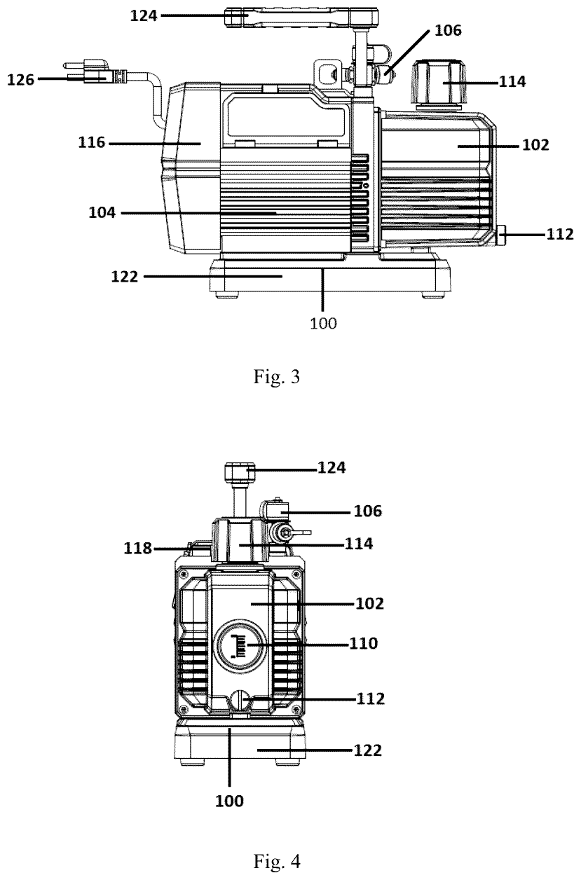

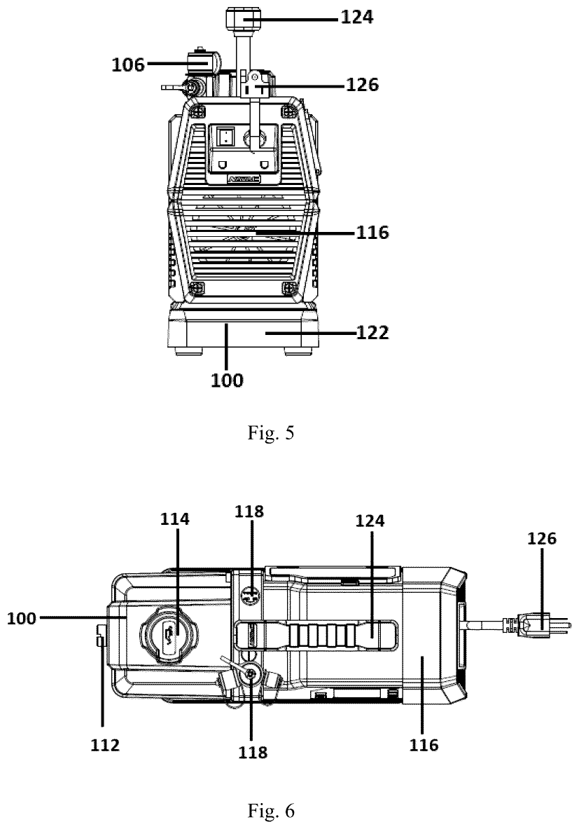

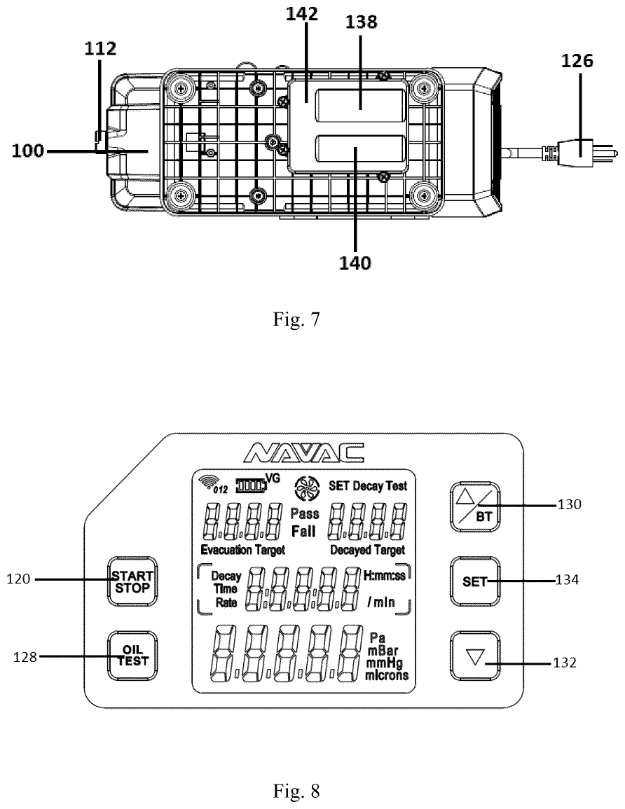

FIGS. 1-7 illustrates different views of a vacuum pump 100 according to one embodiment of the present invention. FIG. 1 shows a perspective view of vacuum pump 100; FIG. 2 shows a front view of vacuum pump 100; FIG. 3 shows a back view of vacuum pump 100; FIG. 4 shows a left side view of vacuum pump 100; FIG. 5 shows a right side view of vacuum pump 100; FIG. 6 shows a top view of vacuum pump 100; and FIG. 7 shows a bottom view of vacuum pump 100.

As shown in FIGS. 1-7, vacuum pump 100 includes oil tank 102 for containing oil, motor 104 for providing power, at least an inlet 106 to be connected (directly or indirectly) to a vacuum gauge. The vacuum pump includes a built-in module or function (e.g., via internal processor) configured for conducting an internal oil health test to assess condition of the oil contained within the oil tank. The vacuum pump may include other components such as oil lens 110, oil drain plug 112, oil mist filter 114, back cover 116, Gas Ballast valve 118, start/stop key 120, base 122, handle 124, grounding plug 126, running capacitor 138, starting capacitor 140, Capacitor Box Cover 142, etc. In some embodiments, vacuum pump 100 further includes an interface 108 (e.g., with digital display) configured to display data and receive input from a user.

With the built-in, internal oil health test module or function, the vacuum pump can perform the following: predetermining a target vacuum level and a preset time period for the internal oil health test; starting the internal oil health test and running the motor for the preset time period; testing a tested vacuum level within the vacuum pump at the end of the preset time period; and comparing the tested vacuum level with the target vacuum level, in order to assess the condition of the oil and determine if an oil change is recommended.

The target vacuum level and preset time period can be predetermined by the built-in module, based on a previously determined relationship among vacuum level achievable by the vacuum pump, standard time required to achieve said vacuum level, and condition of oil contained in the vacuum pump.

For instance, within the HVAC technician community, technicians believe that evacuating the HVAC system to below 100-300 microns is sufficient. Accordingly, the vacuum pump according to the present invention may set 100 microns as the target vacuum level or target threshold, and 1 minute as the preset time period, in order to determine oil condition after the vacuum pump runs for 1 minute.

In some embodiments, the target vacuum level and the preset time period are also adjustable by the user via the interface.

FIG. 8 illustrates an exemplary interface according to one embodiment of the present invention. For instance, the interface may include the following keys for control interface: start/stop key 120, oil test key 128 (for entering oil detection interface and performing oil health test), up key 130 to increase the value of flashing numbers, down key 132 to decrease the value of flashing numbers, Bluetooth connection key to search for a Bluetooth connection in Bluetooth-enabled status (when used with a Bluetooth gauge) 130, set key to enter parameter setting interface 134. The interface may also allow the user to set parameters, such as setting values, time, units, etc.

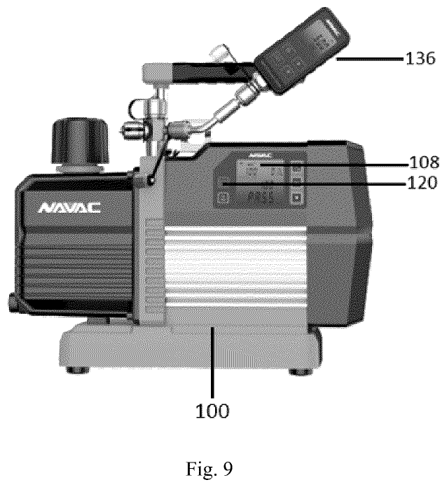

FIG. 9 illustrates a vacuum pump according to the present invention (e.g., the vacuum pump in FIG. 1) with a gauge 136 attached to the pump.

As an example, for an oil health test, the user can perform the steps described below.
1. Remove the Vacuum Gauge connector from side case on top of the pump. Connect one end to the ¼″ air inlet connector and the other end to the vacuum gauge, and ensure the other inlet remains closed.
2. Power on the vacuum and enter the normal operation interface. Press and hold the Bluetooth button for 3 seconds to pair vacuum gauge to the pump with Bluetooth.
3. Press and hold the Oil Test key to access the Oil Health Check function. The interface will display “100”, “Evacuation Target”, “Time”, “1:00”, “min”, “microns” and the current vacuum value with “OIL” flashing. If the vacuum pump is not connected to the vacuum gauge, “OIL” and “NC” flash. Press and hold the Start/Stop Key to exit and return to the previous interface.
4. Press the Start/Stop Key to start the motor and wait for 1 minute for the timer to end. No oil change is needed if the current vacuum value is no more than 100 microns. In this situation, the buzzer will beep 3 times, the backlight panel will flash in sync, and the interface will display a flashing “PASS”. An oil change is necessary if the current vacuum value exceeds 100 microns. The buzzer will beep 12 times, the backlight panel will flash 3 times, and the interface will display a flashing “FAIL”. It will then switch to display flashing “CHANGE” and “OIL”.
5. Go back to normal pump interface, press and hold the Start/Stop key for 3 seconds to exit the oil test mode.

In some embodiments, the vacuum pump according to the present invention can perform decay test to check for leaks in the HVAC system. Still in some embodiments, the vacuum pump's operation and display can be transmitted via Bluetooth to an application on a user's smartphone or tablet. The application combines the power of smart phones/tablets with accurate measurements of the vacuum pump. The operation and display of the vacuum pump are communicated via Bluetooth to the application on smart phones or tablets. Custom reports can be generated by the application to present and summary test results. Information and reports can be saved as documents or sent by e-mail. The application may be compatible with both Apple iOS and Android.

Although specific embodiments and examples of this invention have been illustrated herein, it will be appreciated by those skilled in the art that any modifications and variations can be made without departing from the spirit of the invention. The examples and illustrations above are not intended to limit the scope of this invention. Any combination of embodiments of this invention, along with any obvious their extension or analogs, are within the scope of this invention. Further, it is intended that this invention encompass any arrangement, which is calculated to achieve that same purpose, and all such variations and modifications as fall within the scope of the appended claims.

All the features disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A vacuum pump, comprising:
an oil tank for containing oil;
a motor for producing vacuuming power;
an inlet to be connected either directly or indirectly to a vacuum gauge;
a built-in module configured for conducting an internal oil health test to assess condition of the oil contained within the oil tank.

2. The vacuum pump of claim 1, further comprising an interface configured to display data and receive input from a user.

3. The vacuum pump of claim 1, wherein the internal oil health test is performed after the inlet is connected to the vacuum gauge and the motor is started.

4. The vacuum pump of claim 1, wherein the built-in module is configured to perform the following:
(a) predetermining a target vacuum level and a preset time period for the internal oil health test;
(b) starting the internal oil health test and running the motor for the preset time period;
(c) testing a tested vacuum level within the vacuum pump at the end of the preset time period; and
(d) comparing the tested vacuum level with the target vacuum level, in order to assess the condition of the oil and determine if an oil change is recommended.

5. The vacuum pump of claim 1, wherein when the tested vacuum level is less than or equal to the target vacuum level, the condition of the oil is determined to be good and pass the test; and when the tested vacuum level exceeds the target vacuum level, the condition of the oil is determined to be not good, and the oil change is recommended.

6. The vacuum pump of claim 1, the interface is configured to receive data from the built-in module and display test results or recommendation for the oil change after the internal oil health test.

7. The vacuum pump of claim 1, wherein the target vacuum level and preset time period are predetermined by the built-in module, based on a previously determined relationship among vacuum level achievable by the vacuum pump, standard time required to achieve said vacuum level, and condition of oil contained in the vacuum pump.

8. The vacuum pump of claim 1, wherein the target vacuum level and the preset time period are adjustable by the user via the interface.

9. The vacuum pump of claim 1, further comprising a connector configured to connect the inlet and the vacuum gauge.

10. The vacuum pump of claim 1, wherein the connector is contained within a base of the vacuum pump and movable by the user.

11. The vacuum pump of claim 1, wherein the vacuum gauge is contained by or attached to the pump.

12. The vacuum pump of claim 1, wherein the inlet is a ¼″ air inlet.

13. A method for assessing condition of oil contained in a vacuum pump, comprising the following steps:
(a) connecting a vacuum gauge to an inlet of the vacuum pump;
(b) predetermining a target vacuum level and a preset time period for an internal oil health test;
(c) starting the internal oil health test and running motor in the vacuum pump for the preset time period;
(d) testing a tested vacuum level within the vacuum pump at the end of the preset time period; and
(e) comparing the tested vacuum level with the target vacuum level, in order to assess the condition of the oil and determine if an oil change is recommended.

14. The method of claim 13, wherein the internal oil health test is conducted by a built-in module in the vacuum pump.

15. The method of claim 14, wherein the target vacuum level and the preset time period are predetermined by the built-in module, based on a previously determined relationship among vacuum level achievable by the vacuum pump, standard time required to achieve said vacuum level, and condition of oil contained in the vacuum pump.

16. The method of claim 13, wherein the inlet is a ¼″ air inlet.

17. The method of claim 13, wherein the inlet is connected to the vacuum gauge by a connector, said connector being contained by the vacuum pump and movable by a user.

18. The method of claim 13, further comprising a step of displaying test results or recommendation of the oil change on an interface contained by the vacuum pump.

19. The method of claim 18, wherein the target vacuum level and the preset time period are adjustable by the user via the interface.

20. The method of claim 13, wherein the vacuum pump is the vacuum pump according to claim 1.
